(19) United States
(12) Patent Application Publication
(10) Pub. No.: US 2025/0083439 A1
(43) Pub. Date: Mar. 13, 2025

(54) LIQUID EJECTION HEAD AND METHOD FOR MANUFACTURING LIQUID EJECTION HEAD

(71) Applicant: CANON KABUSHIKI KAISHA, Tokyo (JP)

(72) Inventors: TAKAMITSU TOKUDA, Kanagawa (JP); SATOSHI KIMURA, Kanagawa (JP); TAKUYA IWANO, Tokyo (JP); TOMOKI TSUJI, Kanagawa (JP)

(21) Appl. No.: 18/829,854

(22) Filed: Sep. 10, 2024

(30) Foreign Application Priority Data
Sep. 11, 2023 (JP) 2023-146711

(51) Int. Cl. B41J 2/14; B41J 2/16

(52) U.S. Cl. CPC B41J 2/14072; B41J 2/14112; B41J 2/1601; B41J 2/1623; B41J 2002/14491

(57) ABSTRACT

Provided is a liquid ejection head and a method for manufacturing the liquid ejection head, in which a capacitor can be disposed near an element substrate without increasing the size of the ejection head. To this end, a side surface of a support member includes a concave portion at a position facing an electronic component, the side surface intersecting with a support surface where the element substrate is supported.

### BACKGROUND

### Field of the Disclosure

The present disclosure relates to a liquid ejection head and a method for manufacturing the liquid ejection head.

### Description of the Related Art

A typical liquid ejection apparatus equipped with an ejection head having an element substrate has a plurality of the element substrates arrayed on the ejection head and ejects a large number of droplets simultaneously to achieve fast processing. A wiring board for supplying power and ejection signals is connected to each element substrate. In a case where the element substrate is configured to eject liquid through the thermal action of a heat generating resistor, ringing may occur upon flowing of high current to the wiring board. This ringing may cause high current to flow to a parasitic transistor of a field-effect transistor, which is a driving element, and cause the driving element to malfunction. To reduce occurrence of such malfunction, it is a typical practice to dispose a capacitor at the wiring board of an ejection head, at a location near a connection to the element substrate.

A typically-used ejection head has a capacitor mounted at a flexible wiring board. Such a capacitor needs to be provided in such a manner as to be protected from contacting ink by being sealed with a sealant and not to be in contact with other members.

Japanese Patent Laid-Open No. 2018-192676 discloses a configuration of an ejection head in which a capacitor mounted at a flexible wiring board is surrounded and covered by a sealant and is disposed in a concave portion formed at a support member supporting an element substrate.

In the configuration in Japanese Patent Laid-Open No. 2018-192676, the capacitor is sealed by a sealant and thus provided not to come into contact with other members. However, because the element substrate and the sealed capacitor are disposed side by side in the direction of the surface of the element substrate, it may be difficult to downsize the ejection head.

### SUMMARY

Thus, the present disclosure provides a liquid ejection head and a method for manufacturing the liquid ejection head, in which a capacitor can be disposed near an element substrate without increasing the size of the ejection head.

To this end, a liquid ejection head of the present disclosure is a liquid ejection head including: an element substrate that ejects liquid from an ejection port through an action of an element; a support member that supports the element substrate; a flexible wiring board electrically connected to the element substrate; and a capacitor mounted at the flexible wiring board, wherein a mount portion of the flexible wiring board where the capacitor is mounted is provided in such a manner as to be slanted relative to a support surface of the support member where the element substrate is supported, and wherein a side surface of the support member has a concave portion at a position facing the capacitor, the side surface intersecting with the support surface.

The present disclosure can provide a liquid ejection head and a method for manufacturing the liquid ejection head, in which a capacitor can be disposed near the an element substrate without increasing the size of the ejection head.

Further features of the present disclosure will become apparent from the following description of exemplary embodiments with reference to the attached drawings.

### BRIEF DESCRIPTION OF THE DRAWINGS

FIG. 1 is a perspective view showing a liquid ejection apparatus;

FIG. 2 is a perspective view showing a liquid ejection head;

FIG. 3 is a sectional view showing an area around an electric wiring board at the liquid ejection head;

FIG. 4 is a side view showing a second support member and a third support member;

FIG. 5 is a sectional view taken along V-V in FIG. 4;

FIG. 6 is a sectional view taken along VI-VI in FIG. 4;

FIG. 7 is a sectional view taken along VII-VII in FIG. 4;

FIG. 8 is a perspective view showing the second support member and the third support member; and

FIG. 9 is a flowchart showing a process of manufacturing the liquid ejection head.

### DESCRIPTION OF THE EMBODIMENTS

An embodiment of the present disclosure is described below with reference to the drawings. The following description is not intended to limit the scope of the present disclosure. Although a thermal liquid ejection head, which ejects liquid by having heating resistance elements generate air bubbles, is used as an example in the present embodiment, the present disclosure can also be applied to liquid ejection heads employing other liquid ejection methods such as a piezoelectric method.

Also, although the liquid ejection apparatus in the present embodiment employs a mode where liquid such as ink is circulated between a tank and a liquid ejection head, other modes may be employed. For example, instead of circulating ink, the liquid ejection apparatus may employ a mode where two tanks are provided at an upstream side and a downstream side of the liquid ejection head, and ink in pressure chambers is moved by ink flowing from one of the tanks to the other one.

Further, although the liquid ejection head of the present embodiment is what is called a line-type head, which has a length corresponding to the width of a sheet, the present disclosure can also be applied to what is called a serial-type liquid ejection head, which ejects liquid while moving relative to a sheet. For example, a serial-type liquid ejection head may be configured including a single element substrate for black ink and a single element substrate for color ink, but the present disclosure is not limited to this. Specifically, a short line head which has several element substrates arranged such that ejection ports may overlap in an ejection port array direction and which is shorter than the width of a sheet may be created and scanned relative to a sheet.

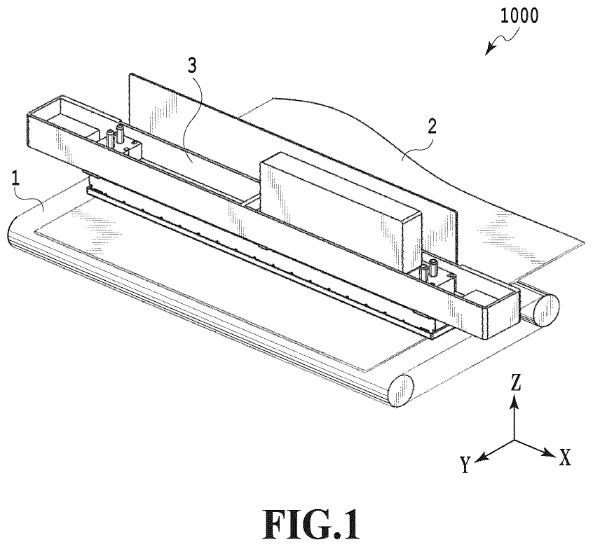

FIG. 1 is a perspective view showing a liquid ejection apparatus 1000 to which the present embodiment can be applied. The liquid ejection apparatus 1000 is a line-type liquid ejection apparatus which includes a conveyance unit 1 configured to convey a sheet 2 and a line-type liquid ejection head 3 disposed substantially orthogonal to a sheet conveyance direction and performs an ejection process with one pass while a plurality of sheets 2 are conveyed continuously or intermittently. The sheet 2 is not limited to a cut sheet and may be a continuous roll of paper. The liquid ejection apparatus 1000 is configured to be able to eject full color liquids by having four unicolor liquid ejection heads 3 arranged in the conveyance direction of the sheet 2, the four liquid ejection heads 3 corresponding to four types of ink, namely CMYK inks. Note that FIG. 1 shows a single unicolor liquid ejection head 3.

The liquid ejection head 3 is fluidically connected to a main tank (not shown) and a buffer tank (not shown) via a supply channel through which liquid is supplied to the liquid ejection head 3.

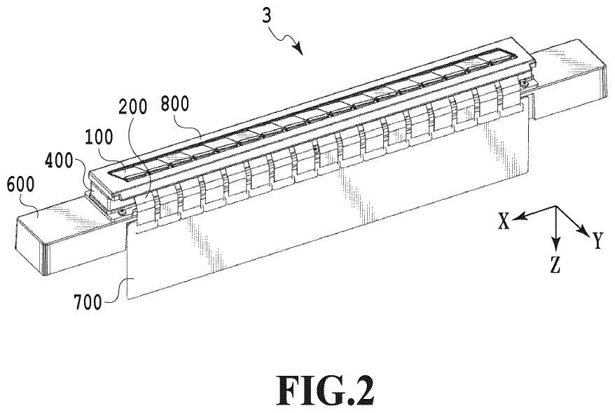

FIG. 2 is a perspective view showing the liquid ejection head 3. The liquid ejection head 3 is a page-wide head having liquid-ejecting element substrates 100 arrayed in the X-direction. The element substrate 100 ejects liquid by having a heating resistance element mounted thereon generate an air bubble. Via an electric wiring board 200, each element substrate 100 is electrically connected to an electric board 700 for controlling ejection operations of the element substrates 100. Electric connections between the element substrates 100 and the electric wiring boards 200 and electric connections between the electric wiring boards 200 and the electric board 700 each has an insulating coating of a sealing member to reduce an electric failure due to intrusion of liquid to an electrode portion. Each element substrate 100 and each electric wiring board 200 are joined and fixed to a first support member 300 to be described later and form an ejection module. Each first support member 300 is joined and fixed to a second support member 400. The second support member 400 is joined and fixed to a third support member 600.

Liquid flow channels are formed in the first support member 300 and the second support member 400 to supply liquid to the element substrates 100. A cover member 800 is disposed around the element substrates 100 and forms a surface with which a suction recovery cap for removing bubbles in the flow channels comes into contact.

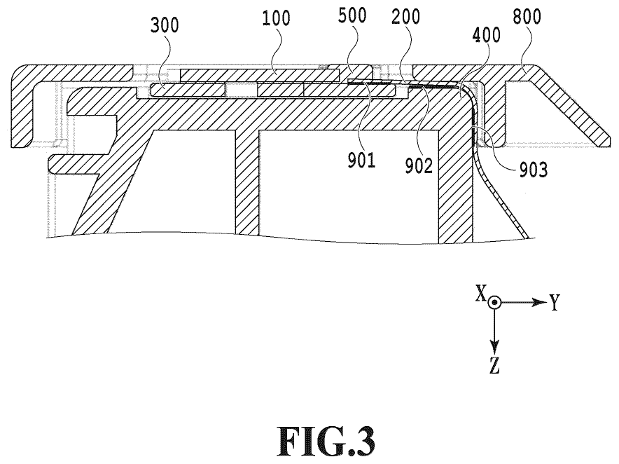

FIG. 3 is a sectional view showing an area around the electric wiring board 200 at the liquid ejection head 3. The electric wiring board 200 is a flexible wiring board with flexibility. One end of the electric wiring board 200 is electrically connected to the element substrate 100, and a region including this connection is joined to the first support member 300 at a first surface (support surface) 901. A portion of the electric wiring board 200 which is away from the aforementioned connection by a predetermined distance is joined to the second support member 400 at a third surface 903 of the second support member 400. The third surface 903 is a surface substantially orthogonal to the first surface 901. An adhesive for joining the electric wiring board 200 and the third surface 903 preferably has a lower modulus of elasticity than an adhesive for joining the electric wiring board 200 and the first surface 901. The electric wiring board 200 and a second surface 902 of the second support member 400 substantially horizontal relative to the first surface 901 may be bonded with an adhesive with a lower modulus of elasticity than the adhesive for joining the electric wiring board 200 and the first surface 901, or a space between the electric wiring board 200 and the second surface 902 may be filled with a sealant. However, this joint is not essential.

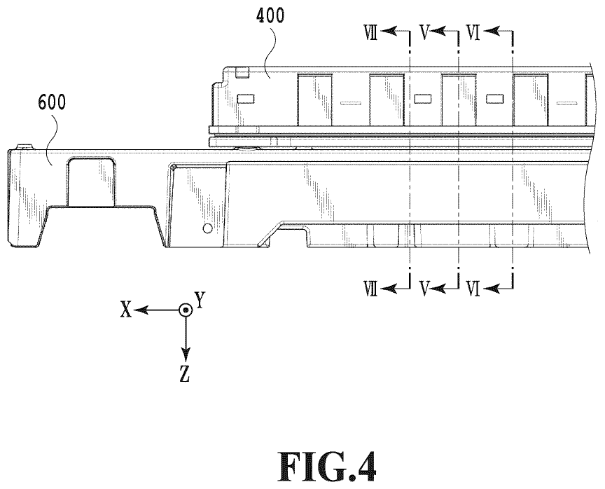

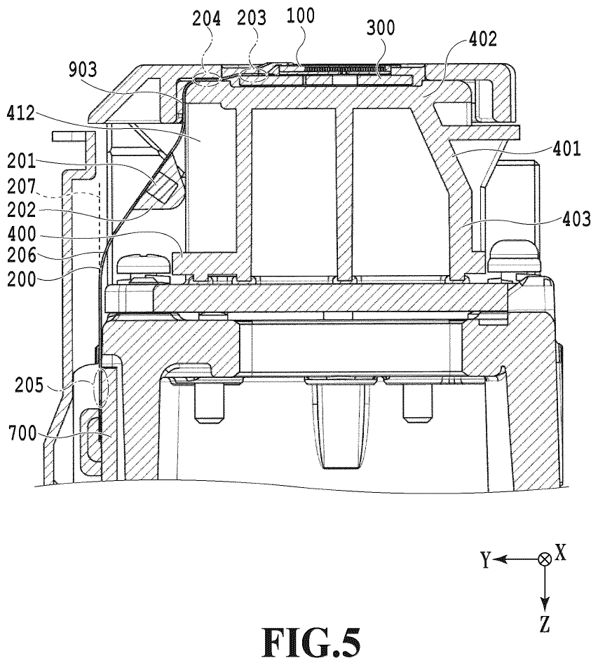

FIG. 4 is a side view showing the second support member 400 and the third support member 600. FIG. 5 is a sectional view taken along V-V in FIG. 4. Note that FIG. 4 omits the electric wiring boards 200 to make it easier to see the second support member 400 and the third support member 600. As shown in FIG. 5, a capacitor (an electronic component) 201 is mounted at the electric wiring board 200 near a connection to the element substrate 100 (at a mount portion), and the mounted capacitor 201 is covered with a sealant 202. The capacitor 201 is disposed near the element substrate 100 to stabilize voltage for driving the heating resistance element and to thereby reduce malfunction. The electric wiring board 200 is bonded to the first support member 300 at a first bond portion 203 with, for example, an adhesive and is bonded to the second support member 400 at a second bond portion 204 with, for example, an adhesive. The second bond portion 204 is a bond portion of the electric wiring board 200 to the second surface 902 and the third surface 903 of the second support member 400 (see FIG. 3). The electric wiring board 200 is also bonded to the electric board 700 at a third bond portion 205 with, for example, a double-sided adhesive, the third bond portion 205 being farther away from the connection to the element substrate 100 than the second bond portion 204 is. The electric wiring board 200 is not particularly fixed at the location where the capacitor 201 is mounted, which is between the second bond portion 204 and the third bond portion 205.

A portion of the electric wiring board 200 between the second bond portion 204 and the third bond portion 205 is disposed such that part thereof is slanted to reduce the width in the liquid ejection apparatus 1000 in the Y-direction. Note that the electric wiring board 200 is bonded and fixed between the second bond portion 204 and the third bond portion 205 with some length to spare. The electric wiring board 200 has more length to spare in a case where an angle formed by the electric wiring board 200 and an imaginary surface 207 which is an extension of the surface of the electric board 700 from the third bond portion 205 in the -Z-direction is small at a bent portion 206 of the electric wiring board 200. As a result, at the location on the electric wiring board 200 where the capacitor 201 is mounted, there is a larger area where the electric wiring board 200 can shift in position upon shaking of the liquid ejection apparatus 1000 during operation, which makes it difficult for the electric wiring board 200 to receive tension.

Meanwhile, the electric wiring board 200 has less length to spare in a case where the angle formed by the electric wiring board 200 and the imaginary surface 207 which is an extension of the surface of the electric board 700 from the third bond portion 205 in the -Z-direction is large at the bent portion 206 of the electric wiring board 200. As a result, there is a smaller area where the electric wiring board 200 can shift in position upon shaking of the liquid ejection apparatus 1000 during operation, which makes it easy for the electric wiring board 200 to receive tension, and the electric wiring board 200 may become disconnected. For this reason, it is desirable that the angle between the electric wiring board 200 and the imaginary surface 207 which is an extension of the surface of the electric board 700 from the third bond portion 205 in the -Z-direction be 20 degrees or greater and smaller than 60 degrees at the bent portion 206 of the electric wiring board 200.

In a case where the second support member 400 comes into contact with the sealant 202 for the capacitor 201 mounted at the electric wiring board 200, the capacitor 201 may become damaged or the wiring of the electric wiring board 200 may become disconnected by an impact of contact upon shaking of the liquid ejection apparatus 1000 during operation. However, reducing the thickness of the second support member 400 to avoid interference of the second support member 400 with the sealant 202 lowers strength. Also, disposing the sealant 202 for the capacitor 201 at a location sufficiently away from the second support member 400 in order for the sealant 202 for the capacitor 201 not to come into contact while the second support member 400 keeps sufficient thickness increases the width of the liquid ejection head in the Y-direction.

Further, in order to reduce ringing, the capacitor 201 needs to be disposed as close to the element substrate 100 as possible, and the mount position of the capacitor 201 cannot be moved away from the element substrate 100 too much just to avoid interference with the second support member 400.

Thus, in the present embodiment, as shown in FIG. 5, a concave portion 412 is provided at a side surface of the second support member 400 at a location where the sealant 202 for the capacitor 201 interferes with the second support member 400 (the side surface being a surface intersecting with the support surface where the element substrate 100 is supported). The width of the concave portion 412 in the X-direction is sufficiently wider than that of the electric wiring board 200 to avoid contact upon shaking of the electric wiring board 200. The concave portion 412 thus provided can avoid contact between the sealant 202 for the capacitor 201 and the second support member 400.

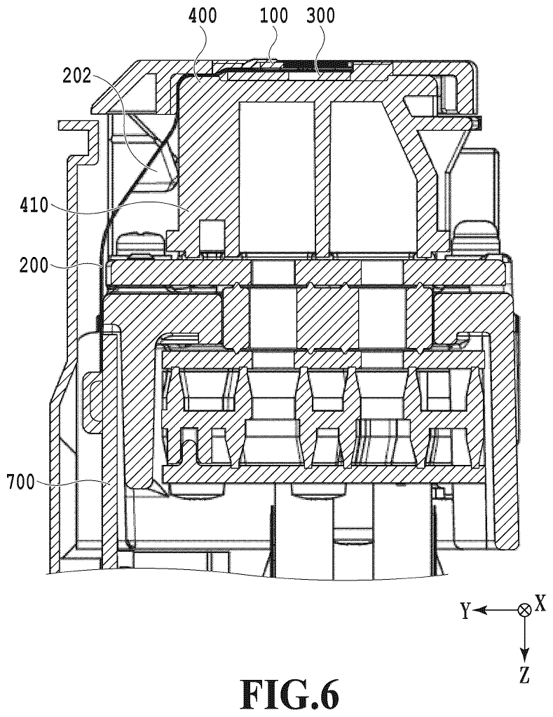

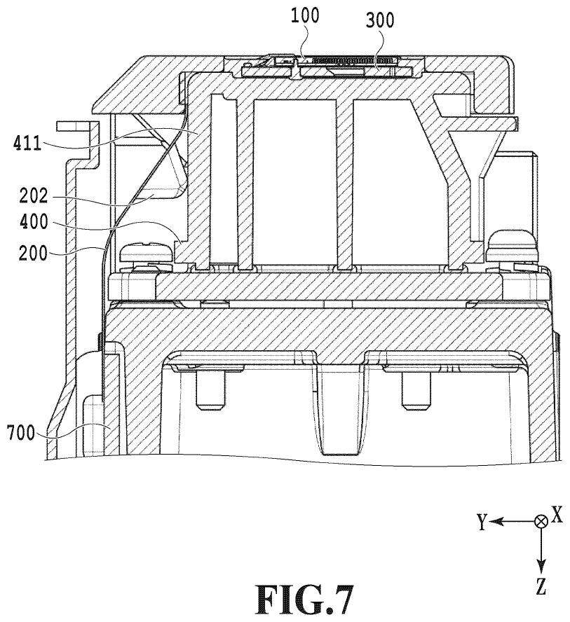

FIG. 6 is a sectional view taken along VI-VI in FIG. 4, and FIG. 7 is a sectional view taken along VII-VII in FIG. 4. As shown in FIG. 6, to ensure strength, a thick portion 410 where the thickness of the side surface of the second support member 400 is thicker is provided at a location where the sealant 202 for the capacitor 201 and the second support member 400 do not interfere with each other. Note that in order to improve moldability, as shown in FIG. 7, part of the thick portion 410 includes a thin portion 411 having a space provided inside. The thickness of a wall forming the thick portion 410 (the width in the Y-direction) is 6.8 mm, the thickness of a wall forming the thin portion 411 (the width in the Y-direction) is 2.3 mm, and the thickness of a wall forming the concave portion 412 is 1.5 mm.

As shown in FIG. 5, the second support member 400 has an elongated shape with a U-shape cross section opened in the Z-direction, and for this reason, due to contraction at the time of molding, warpage deformation tends to occur such that the side surfaces fall inwards. Thus, to reduce such warpage deformation, the second support member 400 is provided with a slanted portion 401 connecting a top surface 402 and a side surface 403. It is desirable that the slanted portion 401 be provided in such a manner as to connect the top surface 402 and a portion of the side surface 403 which is equal to or greater than half the height thereof in the Z-direction and that the angle between the top surface 402 and the slanted portion 401 be 20 degrees or greater and smaller than 60 degrees.

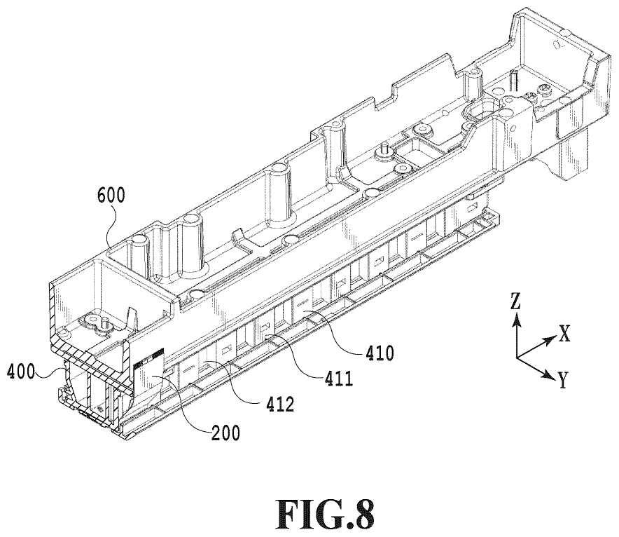

FIG. 8 is a perspective view showing the second support member 400 and the third support member 600. Note that FIG. 8 omits depiction of some of the electric wiring boards 200 and also omits depiction of the electric board 700.

Although no slanted portion is provided at the side surface portion facing the side surface 403, as shown in FIG. 8, the concave portion 412 is provided between the thin portion 411 and the thick portion 410 at the side surface portion facing the side surface 403, and the thin portion 411 and the thick portion 410 are provided alternately, forming a bumpy shape. This shape makes it less likely for warpage deformation to occur.

It is desirable that the mount position of the capacitor 201 at the electric wiring board 200 be near the element substrate 100, and it is desirable that the capacitor 201 be mounted at the electric wiring board 200 at the element substrate 100 side of the center between the element substrate 100 and the electric board 700. In the present embodiment, for example, the capacitor 201 is mounted at a position such that the element substrate 100 side and the electric board 700 side of the capacitor 201 is at the ratio of 2:3. Because the capacitor 201 is used for a power supply line of 30 V, the rated voltage is 50 V, and the capacitance is, for example, 10 μF.

In this way, the concave portions 412 are formed at the side surface of the second support member 400 at positions facing the capacitors 201. As a result, a liquid ejection head and a method for manufacturing the liquid ejection head can be provided, in which the capacitors can be disposed near the element substrates without increasing the size of the ejection head. Although a capacitor alone is described above as an example of an electronic component for reducing the influence of ringing, the electronic component that can be applied to the present disclosure is not limited to this. The electronic component may be, besides a capacitor, a circuit including a resistor or an inductor as long as it is a configuration for reducing the influence of ringing.

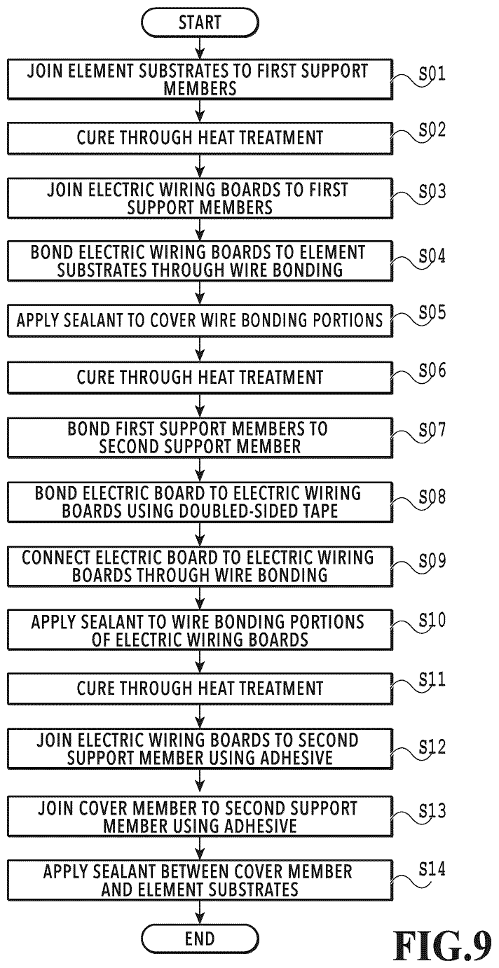

FIG. 9 is a flowchart showing an example process of manufacturing the liquid ejection head 3. Note that the letter “S” in the description of each process means that the process is a step in the flowchart. To manufacture the liquid ejection head 3, first in S01, the element substrates 100 are joined to the first support members 300 using an adhesive. In S02, the adhesive is cured by heat treatment. Then, in S03, one ends of the electric wiring boards 200 are joined to the first support members 300 at the first surface 901, using an adhesive. In S04, the electric wiring boards 200 are bonded to the element substrates 100 through wire bonding. Then in S05, a sealant is applied to cover the wire bonding portions.

In S06, the adhesive and the sealant are cured by heat treatment. In S07, using an adhesive, the first support members 300 are bonded to the second support member 400. Then in S08, the electric board 700 and the electric wiring board 200 are bonded using a double-sided tape. In S09, the electric board 700 is electrically connected to the terminals of the electric wiring boards 200 through wire bonding. In S10, a sealant is applied to cover the wire bonding portions of the electric wiring boards 200.

Then in S11, the sealant is cured by heat treatment. After that, in S12, the electric wiring boards 200 are joined to the second support member 400 using an adhesive, while the capacitors 201 mounted on the electric wiring boards 200 are positioned to face the concave portions 412 formed at the second support member 400. Then in S13, the cover member 800 is joined to the second support member 400 using an adhesive. At this time, the cover member 800 is joined to the electric wiring boards 200 as well using an adhesive. After that, a sealant is applied between the cover member 800 and the element substrates 100, and the liquid ejection head 3 is thus completed.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-146711 filed Sep. 11, 2023, which is hereby incorporated by reference wherein in its entirety.

What is claimed is:

1. A liquid ejection head comprising:
an element substrate that ejects liquid from an ejection port through an action of an element;
a support member that supports the element substrate;
a flexible wiring board electrically connected to the element substrate; and
a capacitor mounted at the flexible wiring board, wherein
a mount portion of the flexible wiring board where the capacitor is mounted is provided in such a manner as to be slanted relative to a support surface of the support member where the element substrate is supported, and
wherein a side surface of the support member has a concave portion at a position facing the capacitor, the side surface intersecting with the support surface.

2. The liquid ejection head according to claim 1, wherein
the capacitor is sealed with a sealant.

3. The liquid ejection head according to claim 1, wherein
the support member has a flow channel for supplying the liquid to the element substrate.

4. The liquid ejection head according to claim 1, wherein
the support member includes a slanted portion located between the support surface and the side surface and slanted relative to the support surface.

5. The liquid ejection head according to claim 4, wherein
the slanted portion is slanted relative to the support surface by 20 degrees or greater and smaller than 60 degrees.

6. The liquid ejection head according to claim 1, wherein
the flexible wiring board is bonded to the element substrate at a first bond portion, bonded to the support member at a second bond portion, and bonded to an electric board at a third bond portion, the electric board being for controlling an ejection operation of the element substrate, and
the capacitor is provided between the second bond portion and the third bond portion.

7. The liquid ejection head according to claim 3, wherein
the side surface includes a thick portion and a thin portion having different thickness to the flow channel at positions different from the concave portion.

8. The liquid ejection head according to claim 7, wherein
the concave portion is provided between the thick portion and the thin portion, and
the thick portion and the thin portion are disposed alternately.

9. The liquid ejection head according to claim 1, further comprising a cover member surrounding the element substrate.

10. The liquid ejection head according to claim 1, wherein
the support member has a first support member and a second support member,
the element substrate is joined to the first support member,
the second support member is joined to the first support member, and
the second support member has the concave portion.

11. The liquid ejection head according to claim 10, wherein
a plurality of the first support members are arrayed and joined to the second support member.

12. The liquid ejection head according to claim 1, wherein
the element is a heating resistance element.

13. A liquid ejection head comprising:
an element substrate that ejects liquid from an ejection port through an action of an element;
a support member that supports the element substrate and has a flow channel for supplying the liquid to the element substrate;
a flexible wiring board electrically connected to the element substrate; and
an electronic component mounted at the flexible wiring board, wherein
a mount portion of the flexible wiring board where the capacitor is mounted is provided in such a manner as to be slanted relative to a support surface of the support member where the element substrate is supported, and
wherein a side surface of the support member has a concave portion at a position facing the electronic component, the side surface intersecting with the support surface.

14. The liquid ejection head according to claim 13, wherein
the electronic component is a capacitor that stabilizes driving voltage applied to the element.

15. A method for manufacturing a liquid ejection head including
an element substrate that ejects liquid from an ejection port through an action of an element,
a support member that supports the element substrate,
a flexible wiring board electrically connected to the element substrate, and
an electronic component mounted at the flexible wiring board, the method comprising:
electrically connecting the flexible wiring board and the element substrate;
bonding the element substrate to a support surface of the support member; and
disposing the flexible wiring board at a side surface of the support member such that a mount portion of the flexible wiring board where the capacitor is mounted is provided in such a manner as to be slanted relative to a support surface of the support member where the element substrate is supported, and the electronic component mounted at the flexible wiring board faces a concave portion formed at the side surface intersecting with the support surface of the support member.

16. The method for manufacturing a liquid ejection head according to claim 15, wherein
the support member has a flow channel for supplying the liquid to the element substrate.
